(19) United States
(12) Patent Application Publication
(10) Pub. No.: US 2021/0040408 A1
(43) Pub. Date: Feb. 11, 2021

(54) LUBRICATING METHOD FOR DRAWING AND LUBRICANT FOR SAID METHOD

(71) Applicant: RAVARINI CASTOLDI & C. S.R.L., Milano (IT)

(72) Inventor: Luigi RAVARINI, Milano (IT)

(21) Appl. No.: 16/968,138

(22) PCT Filed: Feb. 20, 2019
(86) PCT No.: PCT/IB2019/051080

§ 371 Date: Aug. 6, 2020

(30) Foreign Application Priority Data
Feb. 20, 2018 (IT) 102018000002835

(51) Int. Cl. C10M 111/02; C10M 105/24; C10M 101/02

(52) U.S. Cl. CPC C10M 111/02; C10M 105/24; C10N 2040/246; C10M 2290/02; C10M 101/02

(57) ABSTRACT

A method of lubricating metal articles (6), in particular those made of steel, comprising the application (4) of a dispersion comprising a lubricant oil and a lubricant powder to an article to be drawn. A drawing method comprising the lubrication as described above and a lubricant dispersion.

The present invention relates to a drawing process, in particular for steel bars.

Drawing is a process for producing different types of metal products, for example steel bars, with a round or polygonal section, pipes, and wires. Such process requires considerable energy use, which varies notably depending on the type of steel and other process conditions. Different types of expensive pre-treatments are also required, such as heat treatments, which differ depending on the material processed, involving considerable power and installation costs due, for example, to the need for tanks, drying ovens, and equipment of the like.

To reduce friction, thereby making the process possible, accurate lubrication is necessary, which is usually achieved by applying lubricating mineral oils by gravity upstream of the draw unit.

Certain types of powder lubricants have also been developed to allow dry drawing. They are applied to the article, which is run through the powder prior to drawing; the effect of such powders, which are mostly stearate-based, is to greatly facilitate the said drawing, making the aforesaid pre-treatments superfluous in many cases. These powders are mainly used in drawing to produce metal wire. However, the metering out of such powders is not optimal or uniform, which limits the use thereof to the aforesaid field of application. Furthermore, since the powder application method does not ensure constant, precise metering out, it is not reliable. The aforesaid problems have now been solved by means of a method for the lubrication of metal products, in particular bars and pipes, and more particularly those made of steel, comprising the application of a dispersion comprising a lubricating oil and a powder lubricant to the product to be drawn.

The invention concerns, in particular, a method for drawing a metal article, in particular for the production of bars (with a round or polygonal section).

According to a preferred aspect, the application of the dispersion is an electrostatic application. This may be carried out in the same way as for the application of lubricant oils to metal articles, such as sheet metal or strips, for example prior to moulding or for corrosion protection.

The term ‘lubricant oils’ refers to lubricants which are liquid or even solid at room temperature (for example, with a melting temperature ranging from 30 to 70° C.), but which are applied after casting. A process and a system for the electrostatic application of the said solid lubricants to metal strips is disclosed in EP 1 610 902.

The powders may be of any commonly known type available on the market for application in the field of drawing. According to a particular aspect of the invention, the powders in question are stearates.

The invention also relates to a lubricant dispersion for drawing as defined above.

The content of the enclosed claims constitutes particular scope of the invention.

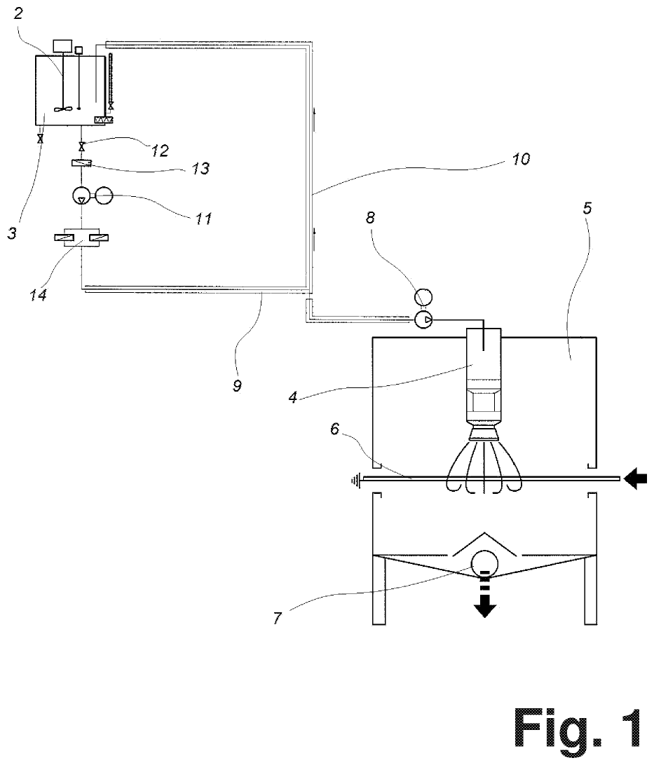

The invention will now be better illustrated by means of the description of a preferred embodiment, provided in the form of a non-limiting example, with the aid of FIG. 1 annexed hereto, which shows a possible diagram of a system capable of implementing a lubrication method according to the present invention.

With reference to FIG. 1, the system comprises a container 3, preferably equipped with an agitator, for example a mechanical agitator 2. This can contain the dispersion, which can be heated and kept at an adequate temperature.

The electrostatic application device may be of any type known in the art and, according to a preferred aspect, the said device features a rotating bell 4, which preferably rotates at a high speed, thereby guaranteeing excellent winding and a good deposition yield.

The device may be provided complete with a booth 5, through which the bar 6 can travel at a variable speed. The base 7 may be connected to a suction filter to collect the undeposited dispersion suspended in the air. This and other electrostatic oiling devices are commonly known and do not require further description. The dispersion flow rate may be regulated by means of a metering pump 8. As in other electrostatic oiling systems, it is possible for line 9—which carries the lubricant to the metering pump from the container 3—to be equipped with a circulation pipe 10 and for the liquid to be kept circulating by means of a circulation pump 11. The lubricant may flow through valves 12, filters for large impurities 13, and a duplex fine filter 14. The exemplified arrangement is similar to those of other electrostatic oiling equipment and may be varied as necessary. If necessary, the pipes may be heated, for example with a heating jacket containing heat-transfer oil to maintain optimal dispersion viscosity. Systems of this type are commonly known and a person skilled in the art would easily be able to design one according to given requirements and process parameters.

The dispersion of powders in lubricant oil offers several advantages compared to the direct application of powders.

The type of powder and in particular particle fineness are no longer critical elements and do not influence deposition yield, unlike with direct deposition of powders. The concentration of the powder dispersed in the oil may be varied considerably in order to identify levels which are suitable for each alloy to be processed, without any limitations attributable to the process, thereby allowing the amount of powder to be varied.

The dispersion temperature may also be varied within a wide range in order to identify the optimal value for each type of metal and of dispersion. The deposition yield is extremely high and this is a typical feature of the electrostatic oiling process, which offers moderate amounts of undeposited lubricant, great ease of abatement, and less environmental pollution. Finally, oil lubrication may be combined with powder lubrication, which could previously only be used in dry drawing, since application of oil after deposition of the powders would have resulted in the at least partial removal of the powders, making it impossible to monitor the amount and uniformity thereof deposited per unit of surface. This allows application to all drawing processes, including the drawing of bars and pipes with large sections and surface areas, which were previously precluded from the application of powders, resulting in a reduction in the power required and in the pre-treatments, and a higher quality end product, while also reducing installation and process costs. It should be noted that dispersion may be achieved simply through agitation (for example, a standard paint agitator has been used) and does not pose particular difficulties in the case of products available on the market commonly used for drawing, such as stearate-based powders and those based on mineral lubricant oils.

By way of example, in a device such as that shown in FIG. 1, the oil used for testing was a drawing oil having a viscosity of mm²/sec at a temperature of 40° C., which is an optimal viscosity level for the deposition of dispersed stearate-based powders base with various particle sizes.

TURBODYN® high-speed rotating bell spray units were tested, which have been used for many years for painting car bodies, for example.

The dispersion may be prepared directly upstream of the system or—given the stability such dispersions have been found to have—they may also be prepared and then stored prior to use.

1. A method of lubricating one of a metal and an alloy article, comprising the following steps:
applying a dispersion comprising a lubricant oil and a lubricant powder to the article to be drawn.

2. The method according to claim 1, wherein the dispersion is applied to the article to be drawn electrostatically.

3. The method according to claim 1, wherein the lubricant oil is a mineral oil, which is liquid at a temperature at which the lubricant oil is applied to the article to be drawn.

4. The method according to claim 1, wherein the lubricant powder is stearate-based.

5. A method according to claim 1, wherein the step of applying the dispersion is carried out by an electrostatic device of a rotating bell kind.

6. A drawing method, comprising:
lubricating an article to be drawn by applying a dispersion comprising a lubricant oil and a lubricant powder.

7. A lubricating dispersion for drawing comprising:
a lubricating oil and
a lubricating powder for drawing.

8. The method according to claim 1, wherein the article to be drawn is made of steel.

9. The method according to claim 6, wherein the article to be drawn is one a steel bars and pipes.

10. The method according to claim 6, wherein the dispersion is applied to the article to be drawn electrostatically.

11. The method according to claim 6, wherein the lubricant oil is a mineral oil, which is liquid at temperature at which the lubricant oil is applied to the article to be drawn.

12. The method according to claim 6, wherein the lubricant powder is stearate-based.
